(19) United States
(12) Patent Application Publication
(10) Pub. No.: US 2010/0113068 A1
(43) Pub. Date: May 6, 2010

(54) HOSTED IMAGERY CAPTURE IN AN AD HOC FOR MOBILE COMPUTING

(75) Inventor: Leigh M. Rothschild, Sunny Isles Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: LMR INVENTIONS, LLC, Sunny Isles Beach, FL (US)

(21) Appl. No.: 12/266,429

(22) Filed: Nov. 6, 2008

(51) Int. Cl. H04W 4/02; H04N 7/18

(52) U.S. Cl. 455/456.3; 348/159; 348/E07.086

(57) ABSTRACT

Embodiments of the present invention provide a method, system and computer program product for digital imagery capture in an ad hoc location for mobile computing devices. In an embodiment of the invention, a method for digital imagery capture in an ad hoc location for mobile computing devices can be provided. The method can include determining a geographic position of a mobile computing device disposed in an ad hoc location and identifying at least one image capture sensor proximate to the determined geographic position. The method also can include directing a selected one of the image capture sensor or sensors to acquire imagery. Finally, the method can include wirelessly forwarding the acquired imagery to the mobile computing device.

### BACKGROUND OF THE INVENTION

1. Field of the Invention

The present invention relates to the field of digital imagery capture and more particularly to digital imagery capture for a mobile computing device.

2. Description of the Related Art

The rapid advancement of computing technology has enabled a host of processing intensive tools. Digital imagery though available in some form for many years, recently has matured into a widely accessible tool in consequence of the development of low cost, high performance computing systems and responsive and accurate sensors. Today, digital imagery finds wide application in both simple and sophisticated still consumer cameras, video and surveillance cameras, cellular telephones, automobiles, personal computers and the like. Quality of resolution for digital imagery has become so refined that digital imagery rivals that of even the most sophisticated analog images.

Notwithstanding, the inclusion of digital imaging tools in mobile computing devices lags mostly due to packaging constraints for mobile computing devices, power requirements of image capture sensors and the additional costs of manufacture associated with the inclusion of digital imaging tools in a mobile computing device. Consequently, when included in mobile computing device, for instance a cellular telephone or personal digital assistant, the functionality of a digital imaging tool can be limited. Generally, the limitations associated with a digital imaging tool included in a mobile computing device relate to the available resolution of the digital imaging sensor and the speed at which a digital image can be acquired.

Of note, in the past mobile computing devices have successfully captured digital imagery acquired from remotely disposed digital image sensors. In particular, video surveillance systems recently have been integrated with video viewing client software disposed within mobile computing devices. In this way, mobile end users can access the video imagery acquired by fixed video cameras in a private geographic location. Notwithstanding, the transmission of video imagery to a mobile computing device in a video surveillance system requires a priori knowledge of the video surveillance system—generally deployed by the end user in residence or commercial premises.

Importantly, end users often require the capture of digital imagery to a mobile computing device in an ad hoc location not anticipated by the end user. Yet, those same end users cannot afford to sacrifice the quality of digital imagery. A typical scenario includes a family vacation. In the typical scenario, the end user is not able to deploy a video surveillance system at the ad hoc location.

### BRIEF SUMMARY OF THE INVENTION

Embodiments of the present invention address deficiencies of the art in respect to digital imaging and provide a novel and non-obvious method, system and computer program product for digital imagery capture in an ad hoc location for mobile computing devices. In an embodiment of the invention, a method for digital imagery capture in an ad hoc location for mobile computing devices can be provided. The method can include determining a geographic position of a mobile computing device disposed in an ad hoc location and identifying at least one image capture sensor proximate to the determined geographic position. The method also can include directing a selected one of the image capture sensor or sensors to acquire imagery. Finally, the method can include wirelessly forwarding the acquired imagery to the mobile computing device.

In another embodiment of the invention, a digital imagery capture data processing system can be configured for digital imagery capture in an ad hoc location for mobile computing devices. The system can include a host computing platform coupled to a multiple different image capture sensors each disposed remotely from one another in different geographic locations. The system also can include a table of sensors corresponding to the different geographic location. Finally, the system can include imagery capture logic coupled to the table and executing in the host computing platform. The logic can include program code enabled to determine a geographic position of a mobile computing device disposed in an ad hoc one of the different geographic locations, to identify in the table at least one of the sensors proximate to the determined geographic position, to direct a selected one of the sensors to acquire imagery, and to wirelessly forward the acquired imagery to the mobile computing device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for digital imagery capture in an ad hoc location for mobile computing devices;

FIG. 2 is a schematic illustration of a digital imagery capture data processing system configured for digital imagery capture in an ad hoc location for mobile computing devices; and,

FIG. 3 is a flow chart illustrating a process for digital imagery capture in an ad hoc location for mobile computing devices.

### DETAILED DESCRIPTION OF THE INVENTION

Embodiments of the present invention provide a method, system and computer program product for digital imagery capture in an ad hoc location for mobile computing devices. In accordance with an embodiment of the present invention, multiple different high-resolution digital imaging sensors can be placed about a geographic region. Each of the sensors can be coupled to a host computing platform including one or more computing servers. The host computing platform can be enabled to communicate wirelessly with proximate mobile computing devices and to locate a geographic position of each of the mobile computing devices. By way of example, global positioning system (GPS) data can be exchanged between each of the mobile computing devices and the host computing platform.

The host computing platform can present a listing of different ones of the sensors to each of the mobile computing devices based upon the located geographic position of each of the mobile computing devices. Thereafter, individual directives can be received from each of the mobile computing devices to acquire digital imagery from a selected one of the listed sensors. In response to the receipt of an imagery capture directive from a particular one of the mobile computing devices, digital imagery can be captured by the selected one of the sensors and forwarded to the particular one of the mobile computing devices for storage. Accordingly, the physical constraints of each of the mobile computing devices need not detract from the quality of digital imagery able to be captured for each the mobile computing devices at an ad hoc location.

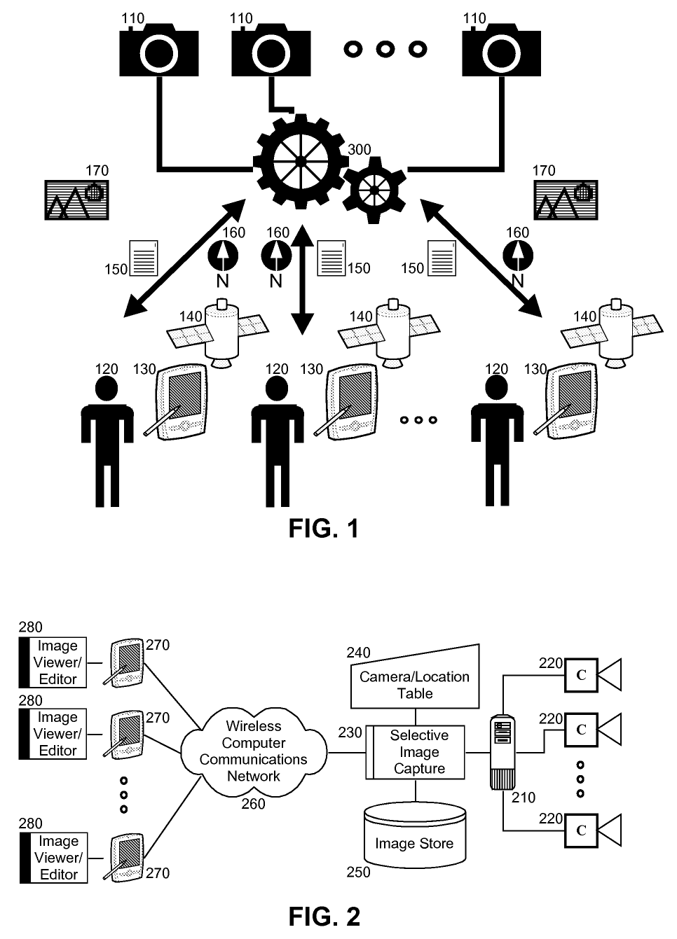

In further illustration, FIG. 1 pictorially shows a process for digital imagery capture for mobile computing devices at an ad hoc location. As shown in FIG. 1, different digital image capturing sensors 110 can be communicatively linked to a digital imagery capture process 300 such that digital imagery 170 can be captured by a selected one of the sensors 110 as directed by the imagery capture process 300. End users 120 at various ad hoc locations can wireless communicate with the imagery capture process 300 through respective mobile computing devices 130. In this regard, the ad hoc locations can be unplanned, contemporaneous locations arising on a case-by-case basis that vary from end user to end user over time. In that the ad hoc locations by definition vary for each of the end users 120, the geographic position 160 for each of the mobile computing devices 130 can be determined by reference to corresponding GPS data 140 and provided to the imagery capture process 300.

In response to the receipt of the geographic position 160 for a requesting one of the mobile computing devices 120, the imagery capture process 300 can determine one or more proximate ones of the sensors 110. Thereafter, the imagery capture process 300 can forward a list 150 of the proximate ones of the sensors 110 to the requesting one of the mobile computing devices 120. In turn, a specific one of the sensors 110 can be selected in the list 150 through the requesting one of the mobile computing devices 120 and provided to the imagery capture process 300. Consequently, the imagery capture process 300 can direct the specific one of the sensors 110 to capture imagery 170 and the imagery capture process 300 can provide the captured imagery 170 to the requesting one of the mobile computing devices 120 for rendering in the mobile computing devices 120.

The process described in connection with FIG. 1 can be embodied within a digital imagery capture data processing system. In more particular illustration, FIG. 2 is a schematic illustration of a digital imagery capture data processing system configured for digital imagery capture for mobile computing devices. The system of FIG. 2 can include a host computing platform 210 communicatively coupled to multiple different geographically disposed image sensors 220. The image sensors 220 can include charge coupled device (CCD) type cameras—both still and video, closed circuit television (CCTV) cameras, and the like. The host computing platform 210 can include one or more computing servers combined to direct the acquisition of imagery by the sensors 220 and to convert acquired imagery to digital form where necessary.

The host computing platform 210 also can support the operation of a selective imagery capture logic 230. The logic 230 further can be coupled both to an image store 250 of acquired imagery, and also a table 240 of the sensors 220 corresponding to respective geographic locations of the sensors 220. The logic 230 further can be configured for communicative coupling over wireless computer communications network 260 to different mobile computing devices 270, for example PDAs, cellular telephones and the like. Each of the mobile computing devices 270 can include an image viewing application 280 that can optionally include image editing functionality such as image resizing, image sharpening, image cropping and image rotation. Further, each of the mobile computing devices 270 can be configured to store acquired imagery provided by the selective imagery capture logic 230.

The selective imagery capture logic 230 can include program code enabled to determine a geographic position of a requesting one of the mobile computing devices 270. As such, the logic 230 further can be enabled to locate one or more of the sensors 220 geographically proximate to the requesting one of the mobile computing devices 270 by reference to the table 240. The logic 230 yet further can be enabled to provide a listing of the geographically proximate ones of the sensors 220 to the requesting one of the mobile computing devices 270. Yet further, the logic 230 can be enabled to respond to a selection of one or more of the sensors 220 in the listing by directing the capture of imagery by the selected sensors 220 and routing the captured imagery to the requesting one of the mobile computing devices 270. The logic 230 even further can be enabled to permit remote operation of the selected one of the sensors 220 by way of pan, tilt, zoom, focus, brighten darken and activation/deactivation of infrared/thermal imaging through the requesting one of the mobile computing devices. Optionally, the logic 230 also can be enabled to store the captured imagery in the image store 250 or in a remote location specified through the requesting one of the mobile computing devices 270.

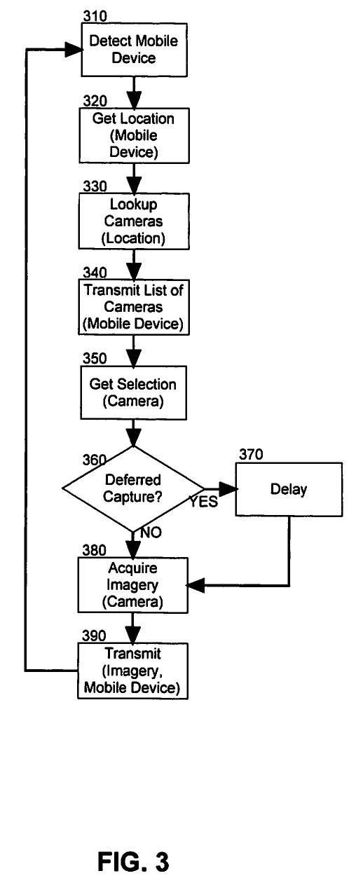

In even yet further illustration of the operation of the imagery capture logic 230, FIG. 3 is a flow chart illustrating a process for digital imagery capture for mobile computing devices. Beginning in block 310, a request for image capture can be received from mobile device disposed in an ad hoc geographic location. In block 320, the geographic position of the mobile device can be determined and in block 330, one or more image capture sensors proximate to the determined geographic position can be determined. In block 340, a listing of the proximate sensors can be provided to the requesting mobile computing device and in block 350, a selection of one or more of the sensors can be received. Alternatively, a most proximate one of the sensors to the determined geographic position can be automatically selected.

In block 360, it can be determined whether an immediate or deferred capture of imagery has been directed by the mobile computing device. In the event of a deferred capture, in block 370 a delay can be imposed. Thereafter, in block 380, imagery can be acquired by the selection of the sensors and in block 390 the acquired imagery can be forwarded to the requesting mobile computing device. Optionally, the acquired imagery can be edited within the mobile computing device and stored within the mobile computing device. Or, alternatively the acquired imagery can be re-routed to a remote computer for storage. Additionally, the acquired imagery can be stored centrally outside of the mobile computing device. In either circumstance, high quality imagery can be accessed within the mobile computing device despite the resource constraints of the mobile computing device and the ad hoc geographic positioning of the mobile computing device.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for digital imagery capture in an ad hoc location for mobile computing devices, the method comprising:
determining a geographic position of a mobile computing device disposed in an ad hoc location;
identifying at least one image capture sensor proximate to the determined geographic position;
directing a selected one of the at least one image capture sensor to acquire imagery; and,
wirelessly forwarding the acquired imagery to the mobile computing device.

2. The method of claim 1, wherein determining a geographic position of a mobile computing device disposed in an ad hoc location, comprises receiving global positioning system (GPS) data locating the mobile computing device from the mobile computing device over a wireless computer communications network.

3. The method of claim 1, wherein directing a selected one of the at least one image capture sensor to acquire imagery, comprises:
providing a listing of multiple image capture sensors proximate to the mobile computing device;
receiving a selection of at least one of the sensors in the listing from the mobile computing device; and,
directing image capture sensors in the selection to acquire imagery.

4. The method of claim 1, wherein directing a selected one of the at least one image capture sensor to acquire imagery, comprises:
delaying a capture of imagery for a pre-determined period of time; and,
directing a selected one of the at least one image capture sensor to acquire imagery subsequent to the pre-determined period of time.

5. The method of claim 1, wherein directing a selected one of the at least one image capture sensor to acquire imagery, comprises:
remotely operating the selected one of the at least one image capture sensor to perform at least one operation selected from the group consisting pan, tilt, zoom, focus, brighten darken and activate/deactivate infrared/thermal imaging; and,
subsequently directing the selected one of the at least one image capture sensor to acquire imagery.

6. A digital imagery capture data processing system configured for digital imagery capture in an ad hoc location for mobile computing devices, the system comprising:
a host computing platform coupled to a plurality of image capture sensors each disposed remotely from one another in different geographic locations;
a table of sensors corresponding to the different geographic locations;
imagery capture logic coupled to the table and executing in the host computing platform, the logic comprising program code enabled to determine a geographic position of a mobile computing device disposed in an ad hoc one of the different geographic locations, to identify in the table at least one of the sensors proximate to the determined geographic position, to direct a selected one of the sensors to acquire imagery, and to wirelessly forward the acquired imagery to the mobile computing device.

7. The system of claim 6, wherein the imagery is a still digital image.

8. The system of claim 6, wherein the imagery is video imagery.

9. The system of claim 6, wherein the mobile computing devices are devices selected from the group consisting of a personal digital assistant (PDA) and a cellular telephone.

10. A computer program product comprising a computer usable medium embodying computer usable program code for digital imagery capture in an ad hoc location for mobile computing devices, the computer program product comprising:
computer usable program code for determining a geographic position of a mobile computing device disposed in an ad hoc location;
computer usable program code for identifying at least one image capture sensor proximate to the determined geographic position;
computer usable program code for directing a selected one of the at least one image capture sensor to acquire imagery; and,
computer usable program code for wirelessly forwarding the acquired imagery to the mobile computing device.

11. The computer program product of claim 10, wherein the computer usable program code for determining a geographic position of a mobile computing device disposed in an ad hoc location, comprises computer usable program code for receiving global positioning system (GPS) data locating the mobile computing device from the mobile computing device over a wireless computer communications network.

12. The computer program product of claim 10, wherein the computer usable program code for directing a selected one of the at least one image capture sensor to acquire imagery, comprises:
computer usable program code for providing a listing of multiple image capture sensors proximate to the mobile computing device;
computer usable program code for receiving a selection of at least one of the sensors in the listing from the mobile computing device; and,
computer usable program code for directing image capture sensors in the selection to acquire imagery.

13. The computer program product of claim 10, wherein the computer usable program code for directing a selected one of the at least one image capture sensor to acquire imagery, comprises:
computer usable program code for delaying a capture of imagery for a pre-determined period of time; and,
computer usable program code for directing a selected one of the at least one image capture sensor to acquire imagery subsequent to the pre-determined period of time.

14. The computer program product of claim 10, wherein the computer usable program code for directing a selected one of the at least one image capture sensor to acquire imagery, comprises:
computer usable program code for remotely operating the selected one of the at least one image capture sensor to perform at least one operation selected from the group consisting pan, tilt, zoom, focus, brighten darken and activate/deactivate infrared/thermal imaging; and,
computer usable program code for subsequently directing the selected one of the at least one image capture sensor to acquire imagery.
